(19) United States
(12) Patent Application Publication
(10) Pub. No.: US 2020/0388838 A1
(43) Pub. Date: Dec. 10, 2020

(54) ALKALINE BATTERY

(71) Applicant: MURATA MANUFACTURING CO., LTD., Kyoto (JP)

(72) Inventors: Masato YAMADA, Kyoto (JP); Kohei SAKANO, Kyoto (JP); Satoshi SATO, Kyoto (JP)

(21) Appl. No.: 16/999,791

(22) Filed: Aug. 21, 2020

Related U.S. Application Data
(63) Continuation of application No. PCT/JP2019/009118, filed on Mar. 7, 2019.

(30) Foreign Application Priority Data
Mar. 23, 2018 (JP) 2018-056440

(51) Int. Cl. H01M 4/42; H01M 4/06; H01M 4/24; H01M 6/08; H01M 2/02; C22C 18/00

(52) U.S. Cl. CPC H01M 4/42; H01M 4/06; C22C 18/00; H01M 6/08; H01M 2/0222; H01M 4/24

(57) ABSTRACT

An alkaline battery includes a negative electrode mixture including a powder of negative electrode active material particles. The negative electrode active material particles includes zinc or a zinc alloy. Indium is presented on the surfaces of the negative electrode active material particles. The average ratio (A/B) of the content A [% by mass] of indium on the surfaces of the negative electrode active material particles to the content B [% by mass] of zinc on the surfaces of the negative electrode active material particles is from 1.2 to 12.2.

### CROSS REFERENCE TO RELATED APPLICATIONS

The present application is a continuation of PCT patent application no. PCT/JP2019/009118, filed on Mar. 7, 2019, which claims priority to Japanese patent application no. JP2018-056440 filed on Mar. 23, 2018, the entire contents of which are being incorporated herein by reference.

### BACKGROUND

The present technology relates to an alkaline battery.

Button-shaped alkaline batteries are widely used in portable game machines, watches, calculators, and the like. In recent years, technologies to improve the storage characteristic of an alkaline battery have been studied.

### SUMMARY

The present technology relates to an alkaline battery.

There is a demand for a technique to improve the storage characteristic of an alkaline battery.

The present disclosure provides an alkaline battery whose storage characteristic can be improved.

According to an embodiment of the present technology, an alkaline battery is provided.

The alkaline battery includes a negative electrode mixture including a powder of negative electrode active material particles including:

zinc or a zinc alloy, and

indium on surfaces of the negative electrode active material particles, wherein

the surfaces of the negative electrode active material particles have a content A [% by mass] of indium and a content B [% by mass] of zinc, and an average ratio (A/B) of the content A to the content B is from 1.2 to 12.2.

According to the configuration as described herein, the capacity retention characteristic of the battery can be improved because the negative electrode active material particles contain indium present on the surfaces of the negative electrode active material particles, and the surfaces of the negative electrode active material particles have the content A [% by mass] of indium and the content B [% by mass] of zinc such that the average ratio (A/B) of the content A to the content B is 1.2 or more and 12.2 or less. Furthermore, the generation of a hydrogen gas can be suppressed. Therefore, the storage characteristic can be improved.

According to an embodiment of the present technology, the alkaline battery preferably includes a negative electrode cup configured to accommodate the negative electrode mixture, the negative electrode cup being provided with a coating layer on an inner surface of the negative electrode cup, the coating layer containing a metal having a hydrogen higher overvoltage than a metal contained in the inner surface of the negative electrode cup.

According to the configuration as described herein, the generation of a hydrogen gas due to a partial battery reaction between the negative electrode cup and the negative electrode active material can be suppressed.

According to an embodiment of the present technology, the average ratio (NIB) is preferably from 3.0 to 12.2, and more preferably from 9.3 to 12.2, from the viewpoint of further improving the storage characteristic.

According to the present technology, the storage characteristic can be improved. It should be understood that the effects described herein are not necessarily limited, and the effect may be any one of the effects described in the description or an effect different from the effects.

### BRIEF DESCRIPTION OF THE FIGURES

FIG. 1 is a sectional view showing an example of the configuration of a battery according to an embodiment of the present disclosure.

FIG. 2 is a graph showing the relationship between the amount of indium hydroxide added and the average ratio (A/B) of the content A of indium on the surfaces of zinc alloy particles to the content B of zinc on the surfaces of the zinc alloy particles according to an embodiment of the present disclosure.

FIG. 3 is a graph showing the relationship between the average ratio (A/B) of the content A of indium on the surfaces of zinc alloy particles to the content B of zinc on the surfaces of the zinc alloy particles and the improvement rate of the capacity retention rate based on that in Comparative Example 1 according to an embodiment of the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example.

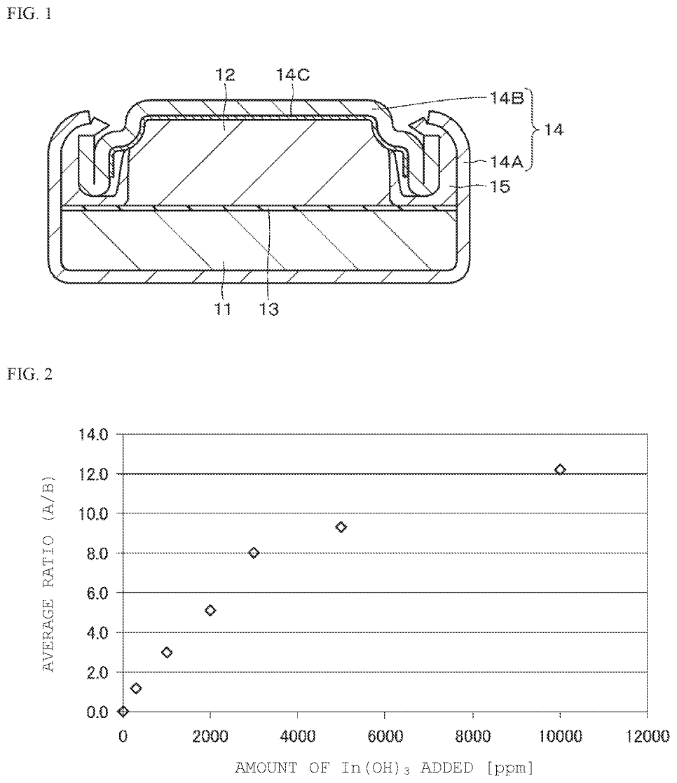

Hereinafter, the configuration of a battery according to one embodiment of the present invention be described with reference to FIG. 1. The battery according to the embodiment of the present invention is a so-called button-shaped alkaline battery (sometimes referred to as a coin-shaped alkaline battery or the like), and includes a disk-shaped positive electrode mixture 11, a disk-shaped negative electrode mixture 12, a separator 13, an alkaline electrolytic solution (not shown), and a button-shaped container 14 housing these constituents.

The container 14 includes a positive electrode can 14A and a negative electrode cup 14B, and the positive electrode can 14A and the negative electrode cup 14B are combined to form a housing space to house the positive electrode mixture 11, the negative electrode mixture 12, the separator 13, and the alkaline electrolytic solution. The positive electrode can 14A has a circular bottom portion and a side wall portion that extends upward from the periphery of the bottom portion. The negative electrode cup 14B has a circular top portion and a side wall portion that extends downward from the periphery of the top portion, and the end portion of the side wall portion is folded back to the outside so as to have a U-shaped section.

The positive electrode can 14A houses the positive electrode mixture 11, and the negative electrode cup 14B houses the negative electrode mixture 12. The positive electrode mixture 11 housed in the positive electrode can 14A and the negative electrode mixture 12 housed in the negative electrode cup 14B face each other with the separator 13 interposed therebetween. The open end portion of the positive electrode can 14A is crimped to seal the container 14. The inside of the sealed container 14 is filled with the alkaline electrolytic solution.

The positive electrode mixture 11 is a coin-shaped pellet, and contains a powder of positive electrode active material particles and a binder. The positive electrode active material particles contain, for example, at least one of silver oxide or manganese dioxide. The binder contains, for example, a fluorine-based resin such as polytetrafluoroethylene.

The positive electrode mixture 11 preferably further contains a silver-nickel composite oxide (nickelite). In this case, when the reaction between the zinc or the zinc alloy contained in negative electrode active material particles and the alkaline electrolytic solution causes the generation of a hydrogen gas, the generated hydrogen gas is absorbed into the silver-nickel composite oxide, so that the increase in the internal pressure of the battery can be suppressed.

The content of the silver-nickel composite oxide in the positive electrode mixture 11 is preferably in the range of 1% by mass or more and 60% by mass or less, and more preferably 5% by mass or more and 40% by mass or less. When the content of the silver-nickel composite oxide is 1% by mass or more, the effect of suppressing the increase in the internal pressure of the battery can be particularly improved. When the content of the silver-nickel composite oxide is 40% by mass or less, the decrease in the content of the negative electrode active material in the positive electrode mixture 11 can be suppressed, and the decrease in the capacity of the battery can be suppressed.

The positive electrode mixture 11 may contain a conductive auxiliary agent in order to improve the electrical conductivity. The conductive auxiliary agent contains, for example, at least one carbon material such as carbon black or graphite.

The negative electrode mixture 12 is in gel form and contains a powder of negative electrode active material particles, the alkaline electrolytic solution, and a thickener. The negative electrode active material particles contain mercury-free zinc or a mercury-free zinc alloy. The zinc alloy contains, for example, zinc and at least one of bismuth, indium, or aluminum. Specific examples of the zinc alloy include alloys containing bismuth and zinc, alloys containing bismuth, indium, and zinc, and alloys containing bismuth, indium, aluminum, and zinc, but are not limited to these alloys.

The content of aluminum in the zinc alloy is, for example, 5 ppm or more and 100 ppm or less. The content of bismuth in the zinc alloy is, for example, 5 ppm or more and 200 ppm. The content of indium in the zinc alloy is, for example, 300 ppm or more and 500 ppm.

Indium is present on the surfaces of the negative electrode active material particles. The presence of indium on the surfaces of the negative electrode active material particles allows the consumption mode of the negative electrode active material during discharge, long-term storage, or the like to proceed not from the insides of the particles but from the surfaces of the particles, and the deterioration (collapse) of the negative electrode active material particles can be suppressed. Therefore, the capacity retention characteristic of the battery can be improved. The presence of indium on the surfaces of the negative electrode active material particles can also suppress the generation of a hydrogen gas. Therefore, the storage characteristic can be improved.

Indium may be present on the surfaces of the negative electrode active material particles as elemental indium or in the form of an indium compound such as indium hydroxide or an indium alloy. Indium may be present on part of the surfaces of the negative electrode active material particles or on the entire surfaces of the negative electrode active material particles. From the viewpoint of improving the storage characteristic of the battery, indium is preferably present on the entire surfaces of the negative electrode active material particles. Indium may be present so as to coat the surfaces of the negative electrode active material particles, or may be scattered on the surfaces of the negative electrode active material particles in a spotted pattern or the like. When indium is present so as to coat the surfaces of the negative electrode active material particles, part of the surfaces of the negative electrode active material particles may be coated, or the entire surfaces of the negative electrode active material particles may be coated. From the viewpoint of improving the storage characteristic of the battery, the entire surfaces of the negative electrode active material particles are preferably coated. negative electrode active material particles to the content B [% by mass] of zinc on the surfaces of the negative electrode active material particles is in the range of 1.2 or more and 12.2 or less, preferably 3.0 or more and 12.2 or less, more preferably 5.1 or more and 12.2 or less, still more preferably 8.0 or more and 12.2 or less, and particularly preferably 9.3 or more and 12.2 or less. When the average ratio (A/B) is less than 1.2, the content A of indium is so small that there is a possibility that the effects of improving the storage characteristic of the battery (specifically, the effect of improving the capacity retention characteristic and the effect of suppressing the generation of a hydrogen gas) are not exhibited. When the average ratio (A/B) is more than 12.2, the content of indium, which is a rare metal, is so large that there is a possibility of increasing the cost required for preparing one battery.

The thickener is a so-called gelling agent, and contains, for example, at least one of carboxymethyl cellulose, polyacrylic acid, or the like.

The alkaline electrolytic solution is, for example, an alkaline aqueous solution in which a hydroxide of an alkali metal is dissolved in water. Specific examples of the alkaline aqueous solution include a sodium hydroxide aqueous solution and a potassium hydroxide aqueous solution, although the kind of alkaline aqueous solution is not limited thereto.

The separator 13 has, for example, a three-layer structure of a nonwoven fabric, cellophane, and a microporous film produced by graft-polymerizing polyethylene. The separator 13 is impregnated with the alkaline electrolytic solution.

A gasket 15 has a ring shape having a J-shaped cross section. The gasket 15 contains, for example, a polymer resin such as polyethylene, polypropylene, or nylon.

The positive electrode can 14A serves not only as a container housing the positive electrode mixture 11, but also as a positive electrode terminal and a positive electrode current collector. The positive electrode can 14A has a configuration, for example, in which a stainless steel plate such as SUS430 is plated with nickel or the like.

The negative electrode cup 14B serves not only as a container housing the negative electrode mixture 12, but also as a negative electrode terminal and a negative electrode current collector. The negative electrode cup 14B includes a three-layer clad material. The three-layer clad material includes a nickel layer, a stainless steel layer provided on the nickel layer, and a copper layer provided on the stainless steel layer as a current collecting layer. The copper layer side is the inside of the negative electrode cup 14B, and the nickel layer side is the outside of the negative electrode cup 14B.

A coating layer 14C containing a metal having a higher hydrogen overvoltage than copper is provided on the inner surface of the negative electrode cup 14B, Since the coating layer 14C is provided on the inner surface of the negative electrode cup 14B, the generation of a hydrogen gas due to a partial battery reaction between the negative electrode cup 14B and the negative electrode active material (zinc or a zinc alloy) can be suppressed. The metal having a higher hydrogen overvoltage than copper contains, for example, at least one of tin, indium, bismuth, or gallium.

Hereinafter, a method for manufacturing a battery according to one embodiment of the present invention will be described. First, a negative electrode active material, an alkaline electrolytic solution, a thickener, and an indium compound are mixed to obtain a gel-like negative electrode mixture 12. At this time, based on 100% by mass of the total amount of all the raw materials in the negative electrode mixture 12, the amount of the indium compound added is in the range of 0.03% by mass or more and 1% by mass or less, preferably 0.1% by mass or more and 1% by mass or less, more preferably 0.2% by mass or more and 1% by mass or less, still more preferably 0.3% by mass or more and 1% by mass or less, and particularly preferably 0.5% by mass or more and 1% by mass or less. When the amount of the indium compound added is 0.03% by mass or more and 1% by mass or less, indium can be precipitated on the surfaces of the negative electrode active material particles so that the average ratio (A/B) is in the range of 1.2 or more and 12.2 or less. As the indium compound, for example, indium hydroxide or the like can be used.

In order to precipitate as much indium as possible on the surfaces of the negative electrode active material particles, the average particle size of the indium compound in this process is in the range of 0.005 μm or more and 5,000 μm or less, preferably 0.01 μm or more and 1,000 μm or less, more preferably 0.50 μm or more and 500 μm or less, and particularly preferably 1.0 μm or more and 200 μm or less. When the indium compound has an average particle size smaller than the range described above, the size of indium precipitated is small, and the effect of suppressing the deterioration of the negative electrode active material is reduced. When the indium compound has an average particle size larger than the range described above, the indium compound cannot be thoroughly dissolved when mixed with the alkaline electrolytic solution and the thickener, and the amount of indium precipitated is reduced. The term “average particle size” means a particle size at a point at which the particle size distribution determined based on the volume is 50% in a cumulative volume distribution curve in which the total volume is 100%, that is, a volume-based cumulative 50% size. The particle size distribution can be determined from a frequency distribution and a cumulative volume distribution curve measured by a laser diffraction/scattering particle size distribution measuring device. The average particle size is measured by sufficiently dispersing the powder of the indium compound in a solvent (ion-exchanged water) by ultrasonication or the like and measuring the particle size distribution. The average particle size can be measured using, for example, a laser diffraction/scattering particle size distribution measuring device (LA-920) manufactured by HORIBA, Ltd.

In this process, by keeping the temperature in an appropriate range during the mixing of the negative electrode active material, the alkaline electrolytic solution, the thickener, and the indium compound, it is possible to increase the binding property of the thickener dissolved with the indium compound in the alkaline electrolytic solution, thus increasing the viscosity of the negative electrode mixture 12. As a result, the indium in the gel-like negative electrode mixture 12 is easily bonded to and retained on the surface of the negative electrode active material, so that indium is easily precipitated over a wide range of the surface of the negative electrode active material. The temperature at this time is preferably 30° C. or more and 80° C. or less, more preferably 35° C. or more and 80° C. or less, and still more preferably 40° C. or more and 80° C. or less.

Next, a positive electrode active material and a binder are mixed to obtain a positive electrode mixture 11, and then the positive electrode mixture 11 is molded into a coin shape. Next, a positive electrode can 14A is prepared, and the positive electrode mixture 11 is put in the positive electrode can 14A. Next, the alkaline electrolytic solution is put into the positive electrode can 14A so that the alkaline electrolytic solution is absorbed into the positive electrode mixture 11.

Next, a separator 13 is placed on the positive electrode mixture 11, and the alkaline electrolytic solution is dropped on the separator 13 to impregnate the separator 13 with the alkaline electrolytic solution. Next, the gel-like negative electrode mixture 12 is placed on the separator 13. Next, a negative electrode cup 14B is prepared, and a coating layer 14C of tin, which has a higher hydrogen overvoltage than copper, is formed on the inner surface of the negative electrode cup 14B. Next, the negative electrode cup 14B is fitted to the opening of the positive electrode can 14A with a gasket 15 therebetween, and then the open end portion of the positive electrode can 14A is crimped to seal a button-shaped container 14 including the positive electrode can 14A and the negative electrode cup 14B. As a result, the intended alkaline battery was obtained.

The alkaline battery according to the embodiment of the present invention includes the negative electrode mixture 12 containing the powder of the negative electrode active material particles containing zinc or a zinc alloy. Indium is present on the surfaces of the negative electrode active material particles. The average ratio (A/B) of the content A [% by mass] of indium on the surfaces of the negative electrode active material particles to the content B [% by mass] of zinc on the surfaces of the negative electrode active material particles is 1.2 or more and 12.2 or less. The presence of indium on the surfaces of the negative electrode active material particles in such a way that the average ratio (A/B) is in the range of 1.2 or more allows the capacity retention characteristic of the battery to be improved and the generation of a hydrogen gas to be suppressed. Therefore, the storage characteristic can be improved. The presence of indium on the surfaces of the negative electrode active material particles in such a way that the average ratio (A/B) is in the range of 12.2 or less allows the increase in the cost required for preparing one battery to be suppressed, and a battery suitable for consumers can be obtained.

### EXAMPLES

Hereinafter, the present invention will be specifically described with reference to Examples, but the present invention is not limited to the Examples described below.

### Example 1

First, a mercury-free zinc alloy powder containing 30 ppm of aluminum, 30 ppm of bismuth, and 300 ppm of indium was prepared as a negative electrode active material. Next, 65% by mass of the zinc alloy powder, 25% by mass of a sodium hydroxide aqueous solution having a concentration of 28% by mass as an alkaline electrolytic solution, 9.97% by mass of carboxymethyl cellulose as a thickener, and 0.03% by mass of indium hydroxide as an indium compound (300 ppm added) were mixed to obtain a gel-like negative electrode mixture.

Next, 69.50% by mass of silver oxide as a positive electrode active material, 20.00% by mass of manganese dioxide as a positive electrode active material, 10% by mass of a silver-nickel composite oxide (nickelite), and 0.50% by mass of polytetrafluoroethylene as a binder were mixed to obtain a positive electrode mixture, and then a coin-shaped positive electrode pellet was formed using the positive electrode mixture. Next, a positive electrode can was prepared by plating a stainless steel plate with nickel, and the positive electrode pellet was put in the positive electrode can. Next, a sodium hydroxide aqueous solution having a concentration of 28% by mass was put into the battery can so that the sodium hydroxide aqueous solution was absorbed into the positive electrode pellet.

Next, as a separator, a circular separator having a three-layer structure of a nonwoven fabric, cellophane, and a microporous film produced by graft-polymerizing polyethylene was prepared, and the separator was placed on the positive electrode pellet. Then, a sodium hydroxide aqueous solution having a concentration of 28% by mass was dropped on the separator to impregnate the separator with the solution, and then the gel-like negative electrode mixture was placed on the separator. Next, as a negative electrode cup, a negative electrode cup including a three-layer clad material including a nickel layer, a stainless steel layer, and a copper layer was prepared, and a coating layer of tin, which has a higher hydrogen overvoltage than copper, was formed on the copper layer side surface of the negative electrode cup. Next, the negative electrode cup was fitted to the opening of the positive electrode can with a ring-shaped nylon gasket therebetween, and then the open end portion of the positive electrode can was crimped to seal a button-shaped container including the positive electrode can and the negative electrode cup. As a result, the intended button-shaped alkaline battery was obtained.

### Example 2

A button-shaped alkaline battery was obtained in the same manner as in Example 1 except that in the process of preparing the negative electrode mixture, the amount of indium hydroxide added was 0.1% by mass (1,000 ppm), and the amounts of the other components were reduced so that the composition ratio among the other components did not change.

### Example 3

A button-shaped alkaline battery was obtained in the same manner as in Example 1 except that in the process of preparing the negative electrode mixture, the amount of indium hydroxide added was 0.2% by mass (2,000 ppm), and the amounts of the other components were reduced so that the composition ratio among the other components did not change.

### Example 4

A button-shaped alkaline battery was obtained in the same manner as in Example 1 except that in the process of preparing the negative electrode mixture, the amount of indium hydroxide added was 0.3% by mass (3,000 ppm), and the amounts of the other components were reduced so that the composition ratio among the other components did not change.

### Example 5

A button-shaped alkaline battery was obtained in the same manner as in Example 1 except that in the process of preparing the negative electrode mixture, the amount of indium hydroxide added was 0.5% by mass (5,000 ppm), and the amounts of the other components were reduced so that the composition ratio among the other components did not change.

### Example 6

A button-shaped alkaline battery was obtained in the same manner as in Example 1 except that in the process of preparing the negative electrode mixture, the amount of indium hydroxide added was 1% by mass (10,000 ppm), and the amounts of the other components were reduced so that the composition ratio among the other components did not change.

### Comparative Example 1

A button-shaped alkaline battery was obtained in the same manner as in Example 1 except that in the process of preparing the negative electrode mixture, no indium hydroxide was added.

By the following procedure, the average ratio (A/B) of the content A [% by mass] of indium on the surfaces of the zinc alloy particles to the content B [% by mass] of zinc on the surfaces of the zinc alloy particles was determined.

(1) First, the battery was disassembled, the negative electrode mixture was taken out and then washed with distilled water, and the zinc alloy powder was separated from the others. Then, the washed zinc alloy powder was dried.

(2) Next, using a scanning electron microscope (SEM), a SEM image of the zinc alloy powder was taken. The SEM measurement conditions are shown below:

SEM: Phenom ProX manufactured by Phenom-World

Accelerating voltage: 15 keV

Magnification: 4300 times

(3) Next, five zinc alloy particles were randomly selected from the SEM image taken in one field of view, and the elemental analysis of the surface of each zinc alloy particle was performed by energy dispersive X-ray spectroscopy (EDX) to determine the content A [% by mass] of indium on the surface of the zinc alloy particle and the content B [% by mass] of zinc on the surface of the zinc alloy particle. Then, the ratios (A/B) on the surfaces of the five zinc alloy particles were calculated and simply averaged (arithmetically averaged) to calculate the average ratio (A/B). The accelerating voltage of EDX was set to 15 keV

The content A [% by mass] of indium and the content B [% by mass] of zinc on the surface of each zinc alloy particle were specifically determined as follows. First, the EDX spectrum of the surface of the zinc alloy particle was acquired, and the peak intensity I_{Unk} (In) specific to indium and the peak intensity I_{Unk} (Zn) specific to zinc were determined. Next, by correcting the ratio I_{Unk} (In)/I_{std} (In) of the peak intensity I_{Unk} (In) to the peak intensity I_{std} (In) of a standard sample, the content A [% by mass] of indium on the surface of the zinc alloy particle was determined. In the same manner, by correcting the ratio I_{Unk} (Zn)/I_{std} (Zn) of the peak intensity I_{Unk} (Zn) to the peak intensity I_{std} (Zn) of a standard sample, the content B [% by mass] of zinc on the surface of the zinc alloy particle was determined.

[Evaluation of Capacity Retention Characteristic]

First, five batteries were prepared in each of Examples 1 to 6 and Comparative Example 1, and were discharged to a final voltage of 1.4 V under a load of 30 kΩ to determine the discharge capacity. Next, the discharge capacities of the five batteries were simply averaged (arithmetically averaged) to determine the average discharge capacity before the storage test. Subsequently, five batteries were prepared in each of Examples 1 to 6 and Comparative Example 1, were stored for 100 days in an environment of 60° C., and were then discharged to a final voltage of 1.4 V under a load of 30 kΩ to determine the discharge capacity. Next, the discharge capacities of the five batteries were simply averaged (arithmetically averaged) to determine the average discharge capacity after the storage test. Then, the capacity retention rate before and after the storage test was determined from the following formula:

Capacity retention rate before and after storage test [%]=((average discharge capacity after storage test)/(average discharge capacity before storage test))×100

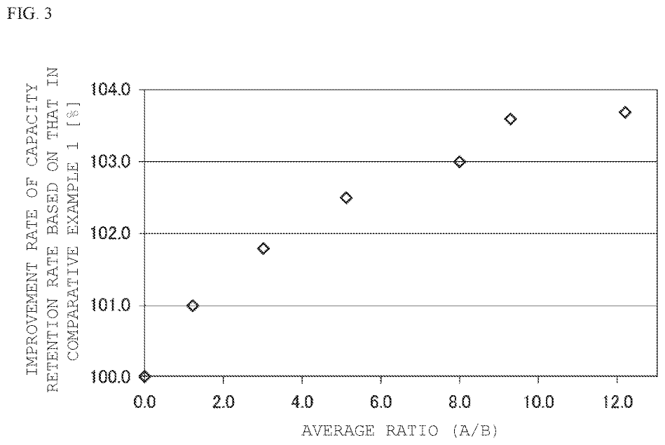

Next, the improvement rate of the capacity retention rate of the batteries in Examples 1 to 6 was determined based on the capacity retention rate of the batteries in Comparative Example 1 in which indium hydroxide was not added (an improvement rate of 100.0%). The results are shown in Table 1. FIG. 2 shows the relationship between the amount of indium hydroxide added and the average ratio (A/B) of the content A of indium on the surfaces of the zinc alloy particles to the content B of zinc on the surfaces of the zinc alloy particles. FIG. 3 shows the relationship between the average ratio (A/B) of the content A of indium on the surfaces of the zinc alloy particles to the content B of zinc on the surfaces of the zinc alloy particles and the improvement rate of the capacity retention rate based on that in Comparative Example 1.

Table 1 shows the configurations and evaluation results of the batteries in Examples 1 to 6 and Comparative Example 1.

TABLE 1

| | | Amount of | | |
|---|---|---|---|---|
| | | indium | | |
| | | hydroxide | | |
| | Content of | added based | | |
| | indium | on 100 | | |
| | hydroxide | parts by mass | | Improvement |
| | in negative | of negative | | rate of |
| | electrode | electrode | Average | capacity |
| | mixture | active material | ratio | retention |
| | [ppm] | [part by mass] | A/B | rate [%] |
| Example 1 | 300 | 0.05 | 1.2 | 101.0 |
| Example 2 | 1000 | 0.15 | 3.0 | 101.8 |
| Example 3 | 2000 | 0.31 | 5.1 | 102.5 |
| Example 4 | 3000 | 0.46 | 8.0 | 103.0 |
| Example 5 | 5000 | 0.77 | 9.3 | 103.6 |
| Example 6 | 10000 | 1.54 | 12.2 | 103.7 |
| Comparative | 0 | 0 | 0.0 | 100.0 |
| Example 1 | | | | |

Ratio A/B: ratio A/B of content A (% by mass) of indium to content B (% by of zinc on surfaces of zinc alloy particles

It can be seen from Table 1 and FIG. 2 that the average ratio (A/B) increases as the amount of indium hydroxide added increases. Furthermore, it can be seen that when the amount of indium hydroxide added is 300 ppm (0.03% by mass) or more, the average ratio (A/B) can be 1.2 or more, and when the amount of indium hydroxide added is 10,000 ppm (1% by mass) or less, the average ratio (A/B) can be 12.2 or less.

It can be seen from Table 1 and FIG. 3 that the capacity retention rate can be improved based on that in Comparative Example 1 by setting the average ratio (A/B) to 1.2 or more. Furthermore, it can be seen that the capacity retention rate improves as the average ratio (A/B) increases.

Although embodiments and Examples of the present invention have been specifically described above, the present invention is not limited to the embodiments and Examples described above, and various modifications can be made based on the technical concept of the present invention.

For example, the configurations, methods, processes, shapes, materials, numerical values, and the like mentioned in the embodiments and Examples described above are merely examples, and different configurations, methods, processes, shapes, materials, numerical values, and the like may be used if necessary.

Furthermore, the configurations, methods, processes, shapes, materials, numerical values, and the like of the embodiments and Examples described above can be combined with each other without departing from the spirit of the present invention.

In the above-described embodiments, the case where the battery is flat has been described, but the shape of the battery is not limited thereto and may be a shape other than the fiat shape.

Furthermore, in the above-described embodiments, the configuration in which the coating layer 14C is provided on the inner surface of the negative electrode cup 14B has been described, but it is not required to provide the coating layer 14C. However, from the viewpoint of suppressing the generation of a hydrogen gas, it is preferable to provide the coating layer 14C as in one embodiment described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An alkaline battery comprising a negative electrode mixture including a powder of negative electrode active material particles including:
zinc or a zinc alloy, and
indium on surfaces of the negative electrode active material particles, wherein
the surfaces of the negative electrode active material particles have a content A [% by mass] of indium and a content B [% by mass] of zinc, and an average ratio (A/B) of the content A to the content B is from 1.2 to 12.2.

2. The alkaline battery according to claim 1, further comprising a negative electrode cup configured to accommodate the negative electrode mixture,
wherein the negative electrode cup is provided with a coating layer on an inner surface of the negative electrode cup, and
wherein the coating layer includes a metal having a hydrogen overvoltage higher than a metal contained in the inner surface of the negative electrode cup.

3. The alkaline battery according to claim 1, wherein the average ratio (A/B) is from 3.0 to 12.2.

4. The alkaline battery according to claim 2, wherein the average ratio (A/B) is from 3.0 to 12.2.

5. The alkaline battery according to claim 1, wherein the average ratio (A/B) is from 9.3 to 12.2.

6. The alkaline battery according to claim 2, wherein the average ratio (A/B) is from 9.3 to 12.2.

7. The alkaline battery according to claim 1, further comprising a separator, wherein the separator includes at least one of a three-layer structure of a nonwoven fabric, a cellophane, and a microporous film.

8. The alkaline battery according to claim 1, wherein the alkaline battery is a button-shaped alkaline battery.
